(19) United States
(12) Patent Application Publication
(10) Pub. No.: US 2004/0244342 A1
(43) Pub. Date: Dec. 9, 2004

(54) Illuminative and reflective safety horse garment

(76) Inventors: Marijan Elizabeth Grogoza, Mansfield, OH (US); Deborah H. Longtin, Feura Bush, NY (US)

Correspondence Address: Jerry K. Mueller, Jr., Mueller and Smith, LPA, 7700 Rivers Edge Drive, Columbus, OH, 43235, US

(21) Appl. No.: 10/821,363

(22) Filed: Apr. 9, 2004

Related U.S. Application Data
(60) Provisional application No. 60/461,867, filed on Apr. 9, 2003.

(51) Int. Cl. B68G 11/00

(52) U.S. Cl. 54/79.4

(57) ABSTRACT

A safety turn out garment for a horse to wear, inter alia, during hunting season and at night, is made from highly visible (e.g., blaze orange) fabric, which may be made from mesh fabric, and has highly reflective strips affixed thereto. Such garment may be made into an equine fly mask or an equine sheet/blanket, which retains the function of conventional equine fly mask or turn out sheet, yet provides better safety for the horse.

### CROSS-REFERENCE TO RELATED APPLICATIONS

This application claims benefit of application Ser. No. 60/461,867, filed on Apr. 9, 2003, the disclosure of which is expressly incorporated herein by reference.

### STATEMENT REGARDING FEDERALLY SPONSORED RESEARCH

Not applicable.

### BACKGROUND OF THE INVENTION

The present invention generally relates to horse garments and more particularly to safety horse garments (e.g., turn out horse fly masks) that provide illuminative and reflective protection to the horse wearing garments.

During hunting season, some horse owners are known to spray paint orange “X's” on the sides of their horses or paint the word “horse” for protection of their pastured horses during hunting season. Other horse owners are known to keep their horses inside their stall for the entire hunting season. Thus, there is an identified need to provide safety to pastured horses during hunting season.

Even though fly season usually is over by the time hunting season arrives, horse fly masks offer an opportunity to provide protection to horses, for example, during hunting season and for climates where flies and mosquitoes are active into hunting season. Moreover, West Nile virus transmitted by mosquitoes is an ever present to horses, even late into the year.

Equine fly masks generally fall into two categories. The first category is for working horses or “under saddle”. That is, horses that are being ridden. The second category is for “turn out”. That is, when the horse is turned out into the field for grazing. The requirements for fly masks (and turn out sheets and blankets for that matter) are different for these two different conditions.

For under saddle, the fly mask must accommodate the bridle (and the blanket must accommodate the saddle, and other saddling gear) used for a rider to mount and ride the horse. As such the fly mask, in particular is rather large to accommodate the bridle and accompanying gear. Such fly mask also typically extends down the length of the horse's head to just above its nose.

For turn out, the fly mask and turn out sheet must be rugged to withstand the horse romping, rolling, jumping, playing with other horses, rubbing against fences/trees/thorns and the like, etc. As such, turn out fly masks and sheets must be relatively rugged to withstand the activities of the horse in the field. The fly mask also must come off easily should it become stuck on a tree limb or branch. Such fly mask typically extends to the end of the horse's cheekbone.

Regardless of which type of fly mask is used, each must provide a degree of protection against flies and other insects (and vermin) from penetrating underneath the fly mask to the horse's eyes. Equine fly masks also provide protection from the sun and sunburn, and from objects (e.g., thorns and branches) from poking the horse's eyes. To that end, all fly masks must accommodate the horse's eyes, ears, forelock, and other physical features of horses. Representative horse fly masks in general can be seen in the following citations: U.S. Pat. Nos. 4,662,156; 6,216,642; 6,128,891; 5,440,864; 6,508,203; 6,463,887; 6,050,068; 5,456,215; 5,345,751; and 5,341,627; U.S. Design Patent D459,556; and U.S. Patent Application Publication No. US 2002/0108586.

An under saddle garment ensemble (fly mask, neck piece, and blanket) is disclosed in U.S. Pat. No. 6,574,948. Such ensemble can be made of material that radiates or reflects visible light. Additionally, reflective strips are shown on the neck and blanket portions of the ensemble.

### BRIEF SUMMARY OF THE INVENTION

An illuminative and reflective safety turn out horse safety mask is made from a bright and highly visible (e.g., international or blaze orange) fabric (e.g., mesh) that has reflective strips adhered to thereto. Additionally, the equine mask can be lighted for additional visibility. The design of the equine safety mask makes it suitable as a fly mask also. “Reflective strips” for present purposes includes, inter alia, reflectivity, iridescence, luminescence, or any other light emitting/reflective/storing material for alerting hunters and others of the presence of the horse.

A preferred illuminative and reflective safety turn out horse safety mask is made from a fabric (e.g., mesh) adapted to extend from a rear edge behind a horse's ears to a lower edge at the cheekbone (i.e., bridge of the nose about midway between the horse's eyes and nose). The fabric has a mesh, pleated area to create a stand-up area to keep the fabric away from the horse's eyes and to permit the horse to see therethrough, and an ear accommodating area formed from an upper edge to accommodate the horse's ears. Ear accommodation includes, inter alia, an earless aperture or ear cones to covert the horse's ears for additional protection. The rear and lower fabric edges terminate about the lower jaw of the horse and thereat are releasably fastenable. Each of the fabric edges is covered with webbing. A first reflective strip is adhered to the fabric about the lower edge. A second reflective strip is adhered to the fabric extending upwardly from the first reflective strip to the ear accommodating area and adapted to be located in the middle of the horse's face.

Advantages of the present inventive include, inter alia, the ability to turn out horses at night to avoid sun and/or heat and/or flies, while providing safety to the horses. Another advantage is the ability to safely turn out some stock during the day while others at night to maximize the utilization of, for example, limited turn out areas. Yet another advantage is to make a loose or run away horse more visible to aid in their safety and to help locate them. These and other advantages will be apparent to those skilled in the art based on the present disclosure.

### BRIEF DESCRIPTION OF THE DRAWINGS

For a fuller understanding of the nature and advantages of the present invention, reference should be had to the following detailed description taken in connection with the accompanying drawings, in which:

FIG. 1 is a front perspective view of the inventive turn out horse fly mask fitted on the head of a horse;

FIG. 2 a side view of the turn out horse fly mask shown in FIG. 1;

FIG. 3 is a front perspective view of an alternative embodiment of the inventive turn out horse fly mask; and

FIG. 4 is a side elevational view of the inventive turn out horse fly mask sown in FIG. 3.

The drawings will be described in detail below.

### DETAILED DESCRIPTION OF THE INVENTION

The equine safety garment of choice for implementing the present invention is an equine turn out fly mask that retains the advantages of conventional fly masks that provide effective protection to the eyes of the horse from flies and other inserts, while concomitantly providing safety to the horse from hunters, automobiles, during fog or other low light situations, and the like. Such protection is provided by the strategic placement of reflective strips on the fly mask in combination with its color. Such reflective strips reflect the light at night, at dusk, at dawn, and even during daylight hours, to provide maximum protection to the horse. That is, when a hunter's or automobile's light shines on the horse, the horse instinctively will turn towards the light. At that time, the reflective strips will reflect light back to the hunter or driver to alert them that the horse is present. Especially during the day, the brightly colored fly mask will be more visible because of its color and reflectivity. It should be understood that reference to a hunter or to an automobile is for illustrative purposes and is not a limitation on the present invention. Suffice it to say that the horse turned out in the field will have an extra degree of protection by dint of the invention turn out equine fly mask.

It will be appreciated that other equine garments (e.g., horse turn out sheets and blankets) could be manufactured in accordance with the precepts of the present invention and provide added safety to the horse, while concomitantly providing comfort to the horse. To that end, such safety sheet or blanket could be made from mesh fabric during warm seasons and from dernier, corduroy, nylon, fleece, or other material, say warmth providing fabric during cold seasons. Rain protection could be provided regardless of the season. Reflective strips, bright colors, and similar attention getting features are provided, as described herein for the safety mask.

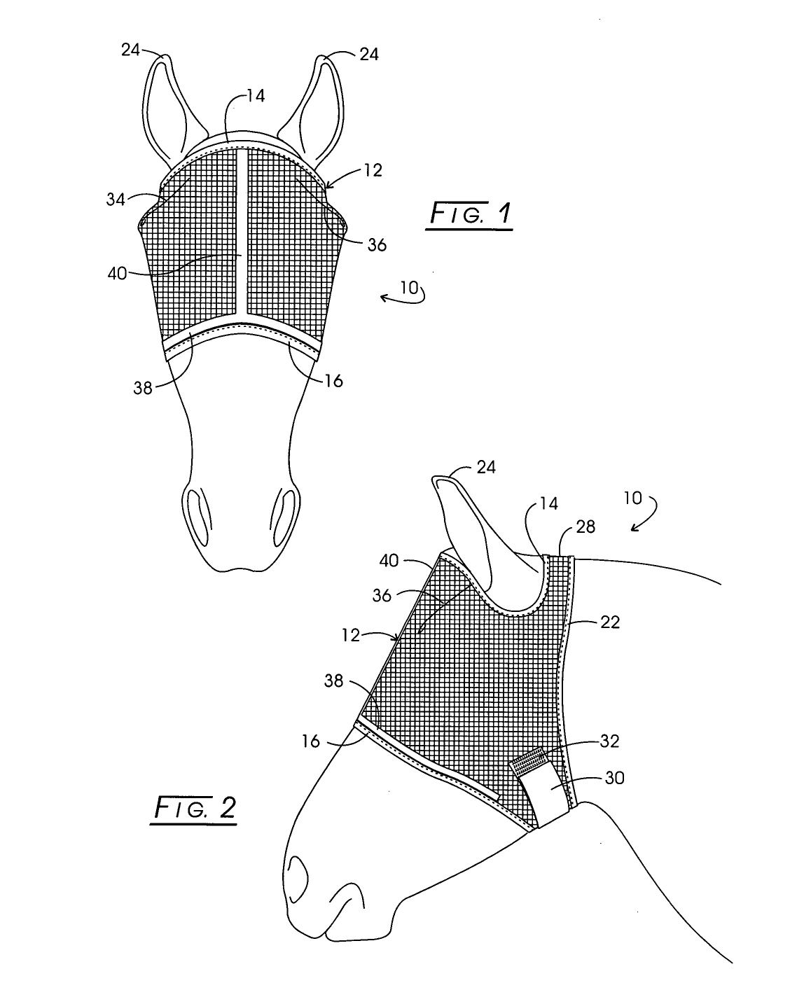

Referring initially to FIGS. 1 and 2, a horse, 10, will be seen wearing inventive turn out equine safety and fly mask, 12. Safety mask 12 is made from a mesh fabric or at least the portion about the horse's eyes will be made from mesh fabric. The remainder of the fly mask can be made from mesh fabric or from a solid fabric, say, for use during winter months. Such fabric preferably will be water proof or water resistant. For that reason, a vinyl or similar polymeric mesh fabric will be used. The mesh size will be of sufficient size to exclude unwanted pests, as those skilled in the art will appreciate. For maximum safety, the material will be highly brightly colored, say, international or blaze orange, international yellow, international green, or the like. The material also can be luminescent material. Alternatively, the fly mask material can be of any other bright color, say, red.

Additionally, the horse safety mask can be lighted for additional safety and protection for the horse. One such lighted material is POLYBRITE® (U.S. Pat. No. 5,879,076, Illumination Polymer Technologies, Inc.), which is a lighted strand of plastic material that can be battery powered.

It will be observed that turn out safety mask 12 extends down below the eyes to about the cheekbones (i.e., about the middle of the horse's head), whereas an under saddle fly mask generally extends to the horse's nose. It also extends rearwardly to just behind the horse's ears to provide securement to the horse.

Additionally, all of the edges of fly mask 12 will be covered with webbing so that the fabric does not rub against the horse and cause irritation or injury. Webbing also will not attract burrs, such as fleece does. Woven webbing is preferred made from a vinyl or other polymeric material (e.g., polypropylene), cotton, polycotton blends, and the like. Such webbing will be smooth to the touch. To that end, an upper edge, 14, is covered with webbing, as is the lower edge, 16. The mating edges, 18 and 20 (see FIG. 3) where fly mask 12 is joined similarly are covered with the webbing. Finally, the rear edge, 22, across the top of the horse's neck is covered with the webbing. The same or different webbing material can be used on each edge. It also is possible to use polar fleece or other covering, provided that such material is of sufficient durability and washability to have a useful life, and provided that such material does not attract and retain thorns, burrs, or the like that might injure and/or cause discomfort to the horse.

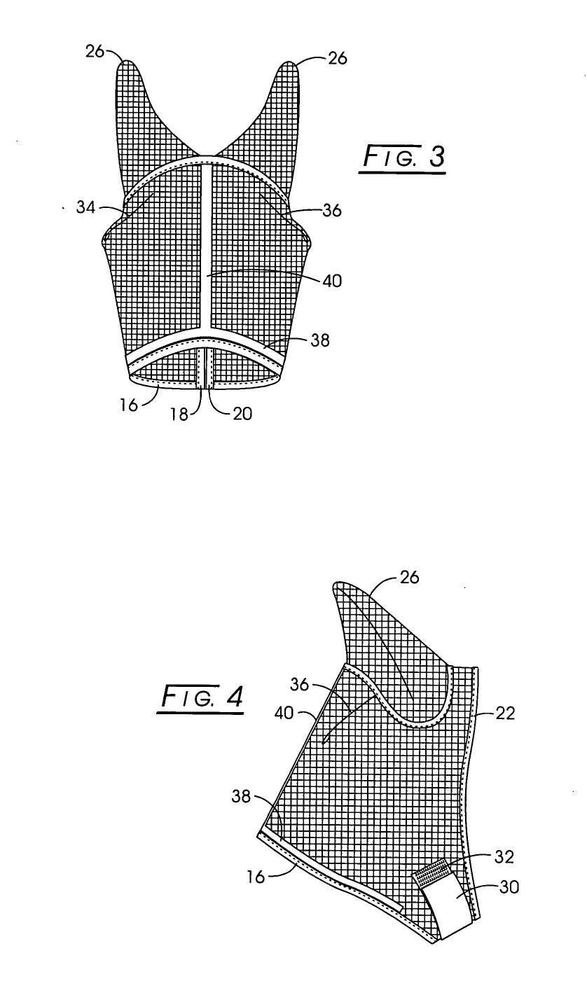

Upper edge 14 forms an aperture through which the horse's ears, 24, and forelock (not shown so as to not obscure fly mask 12) protrude. Alternatively, an earpiece, 26 (see FIGS. 3 and 4) could be attached to upper edge 14 to form an ear cover for horse 10 in conventional fashion. A band, 28, formed between upper edge 14 and rear edge 22 helps fly mask 12 stay in position by being behind ears 24.

Adjacent mating edges 18 and 20 are VELCRO® strips (i.e., hook and eye strips), 30 and 32, which provide closure and secure fly mask 12 to horse 10. Other closure means (e.g., snaps, buttons, etc.) could be provided, as is necessary, desirable, or convenient. However, VELCRO® strips are preferred as they provide easy, yet secure, closure. Moreover, the VELCRO® strips can be pulled undone by the horse should fly mask 12 become caught on a branch, fence post, or the like while the horse is in the field in order to prevent injury to horse 12.

Provision for the horse's eyes are made by sewing darts, 34 and 36, into fly mask 12. Such darts make the fly mask material stand up. Such stand off of the fly mask material keep the material from rubbing against the horse's eyes so that they can be opened and shut.

In order to provide maximum protection to the horse, a highly reflective strip (e.g., SCOTCHLITE® tape, 3M Corporation; or REFLEXITE™ tape, Reflexite Corporation), 38, will be placed just above or slightly on top of the webbing on lower edge 16 running from one lower jaw of the horse to the other lower jaw. Tape 38 can be continuous or intermittent in is placement, though continuous tape is preferred. Additionally, a second, vertical tape, 40, runs upwardly from tape 38 to upper edge 14. Tape 40 runs right up the center of the horse's head. Such tape placements will reflect light from the side as well as the front of horse mask 12. It will be appreciated, however, that such reflective strips could be placed elsewhere on the safety mask, say on the side of the mask, along the back edge at the throat/latch area, or the like. So long as the reflective strips in location and number are sufficient to improve the safety of the horse, the precepts of the present invention have been satisfied.

While the invention has been described with reference to a preferred embodiment, those skilled in the art will understand that various changes may be made and equivalents may be substituted for elements thereof without departing from the scope of the invention. In addition, many modifications may be made to adapt a particular situation or material to the teachings of the invention without departing from the precepts thereof. Therefore, it is intended that the invention not be limited to the particular embodiment disclosed as the best mode contemplated for carrying out this invention, but that the invention will include all embodiments falling within the scope of the appended claims. Also, all citations referred herein are expressly incorporated herein by reference.

I claim:

1. An equine safety turn out garment for a horse to wear during hunting season and at night, which comprises:
an equine garment made from highly visible fabric which has highly reflective strips affixed thereto.

2. The equine safety turn out garment of claim 1, which is lighted for additional visibility.

3. The equine safety turn out garment of claim 1, wherein said fabric is one or more of international or blaze orange.

4. The equine safety turn out garment of claim 1, which is one or more of an equine turn out fly mask or an equine turn out sheet.

5. An illuminative and reflective safety turn out horse fly mask, which comprises:
a high visibility colored fabric adapted to extend from a rear edge behind a horse's ears to a lower edge at the horses cheekbone, said fabric having a mesh pleated area to create a stand-up area away from the horse's eyes and to permit the horse to see therethrough, and an ear accommodating area formed from an upper edge to accommodate the horse's ears, said rear and lower edges terminating about the lower jaw of the horse and thereat being releasably fastenable, each of said fabric edges being covered with webbing, a first reflective strip being adhered to said fabric about said lower edge and a second reflective strip is adhered to the fabric extending upwardly from said first reflective strip in the middle of the horse's face to said ear accommodating area.

6. The turn out horse fly mask of claim 5, which is international orange in color.

7. The turn out horse fly mask of claim 5, wherein said webbing is one or more of vinyl, cotton, or polypropylene.

8. The turn out horse fly mask of claim 5, which is entirely made from mesh fabric.

9. The turn out horse fly mask of claim 5, wherein said fabric is a vinyl fabric.

10. The turn out horse fly mask of claim 8, wherein said mesh fabric is a vinyl mesh fabric.

11. The turn out horse fly mask of claim 5, wherein said ear accommodating area is an aperture formed with said upper edge.

12. The turn out horse fly mask of claim 5, wherein said ear accommodating area is additional fabric adapted to fit over the ears of the horse.

13. The turn out horse fly mask of claim 5, which is releasably fastenable with a hook and eye fastener.

14. The turn out horse fly mask of claim 5, which additionally retains electrically energized lighted strips.

15. A method for providing safety to a turned out horse, which comprises the steps of:
providing an illuminative and reflective safety turn out horse fly mask comprising a high visibility colored fabric adapted to extend from a rear edge behind a horse's ears to a lower edge at the horses cheekbone, said fabric having a mesh pleated area to create a stand-up area away from the horse's eyes and to permit the horse to see therethrough, and an ear accommodating area formed from an upper edge to accommodate the horse's ears, said rear and lower edges terminating about the lower jaw of the horse and thereat being releasably fastenable, each of said fabric edges being covered with webbing, a first reflective strip being adhered to said fabric about said lower edge and a second reflective strip is adhered to the fabric extending upwardly from said first reflective strip in the middle of the horse's face to said ear accommodating area.

16. The method of claim 15, wherein said fabric provided is international orange in color.

17. The method of claim 15, wherein said webbing is one or more of vinyl, cotton, or polypropylene.

18. The method of claim 15, wherein said safety turn out mask is entirely made from mesh fabric.

19. The method of claim 15, wherein said fabric is a vinyl fabric.

20. The method of claim 18, wherein said mesh fabric is a vinyl mesh fabric.

21. The method of claim 15, wherein said ear accommodating area is an aperture formed with said upper edge.

22. The method of claim 15, wherein said ear accommodating area is additional fabric adapted to fit over the ears of the horse.

23. The method of claim 15, wherein said safety turn out mask is releasably fastenable with a hook and eye fastener.

24. The method of claim 15, wherein said safety turn out mask additionally retains electrically energized lighted strips.

25. A safety equine turn out blanket, which comprises:
an equine turn out blanket made from bright and highly visible fabric that has reflective strips adhered to thereto.

26. The safety equine turn out blanket of claim 25, which is lighted for additional visibility.

27. The safety equine turn out blanket of claim 25, wherein said fabric is one or more of international or blaze orange.

28. The safety equine turn out blanket of claim 25, wherein said fabric is mesh fabric.

29 The safety equine turn out blanket of claim 25, wherein said fabric is one or more of vinyl, cotton, polypropylene, dernier, corduroy, nylon, or fleece.

30. The safety equine turn out blanket of claim 25, wherein said fabric is a vinyl fabric.

31. The safety equine turn out blanket of claim 28, wherein said mesh fabric is a vinyl mesh fabric.
